(19) United States
(12) Patent Application Publication
(10) Pub. No.: US 2005/0191157 A1
(43) Pub. Date: Sep. 1, 2005

(54) Storage for bulk goods with overhead withdrawal

(76) Inventor: Klaus-Sweerich Schroder, Aalen (DE)

Correspondence Address: RATNERPRESTIA, P O BOX 980, VALLEY FORGE, PA, 19482-0980, US

(21) Appl. No.: 10/788,910

(22) Filed: Feb. 27, 2004

(51) Int. Cl. B65G 1/00

(52) U.S. Cl. 414/304

(57) ABSTRACT

A storage device for interlocking bulk goods has a storage containers; a feeding device for filling the storage container with the bulk goods; and spiked shafts arranged in the storage container which are rotary driven about their rotational axes and mate with each other in order to convey the bulk goods to be withdrawn from the storage container in a conveying direction perpendicular to their rotational axes. The spiked shafts are arranged such that they engage with the bulk goods in order to withdraw them from above.

The invention relates to a storage device for interlocking bulk goods, and therein in particular to a withdrawing part which serves to withdraw the bulk goods from a storage container of the storage device. Furthermore, the invention also relates to a method for withdrawing interlocked bulk goods from a storage container. The invention is particularly advantageous for withdrawing from storage containers having a large storage capacity with correspondingly heavily interlocked particles of bulk goods.

Bulk goods which largely contain particles of bulk goods or are formed exclusively from particles of bulk goods which tend to interlock are problematic in particular with respect to withdrawing them from the storage container. Bulk goods which are problematic in this way include, for example, household waste and chips for OSB plates (oriented strand boards) and other planar bulk goods. The pressure in the lower region of the storage container increases sharply with increasingly fill level, such that the individual particles of bulk goods generate very large adhesion forces between each other and their mutual interlocking can therefore only be released by a large force.

Conventional withdrawing devices withdraw the bulk goods from the storage container from below, out of the pile of bulk goods. For example, circulatory screws which withdraw by means of rotating screws which wrench the bulk goods out of the pile of bulk goods using pickups on their screw blades. Wrenching and withdrawing the particles of bulk goods by means of hauling arms is furthermore known. In the case of interlocked bulk goods, the conventional withdrawing devices are only suitable for small storage containers, since the adhesion forces of the particles of bulk goods between each other increase with the fill level.

For OSB chips (strands), belt bunkers are used in which the bulk goods are cast onto a conveyor belt which slowly slides the bulk goods into a series of spiked shafts. Newly added strands are drawn into the rear region of the belt bunker by means of a retracting rake in a chain design. The current state of development limits the OSB bunkers to a filling volume of about 500 m³. Designing the retracting rakes in a chain design limits the length of the bunker, since the tensile load on the chain increases with the length of the bunker. The height of the bunker is also limited. Higher bunkers are unsuitable, since the particles of bulk goods on the belt at the bottom would become so compacted that the spiked shafts would no longer be capable of wrenching the strands out of the pile of bulk goods. Even with existing storage devices, the particles of bulk goods are significantly destroyed by the spiked shafts, such that the current. OSB belt bunkers are not optimal with respect to their conveying volume or with respect to treating the particles of bulk goods gently.

It is an object of the invention to gently withdraw interlocked bulk goods accommodated in a storage container from said storage container, in order to be able to increase the storage capacity of storage containers for interlocked bulk goods.

The invention relates to a storage device for interlocked bulk goods, said storage device comprising a storage container for the bulk goods, a feeding device for filling the storage container with the bulk goods and a withdrawing device comprising spiked shafts arranged in the storage container. The spiked shafts are rotary driven about their rotational axes and mate with each other in order to convey the bulk goods to be withdrawn from the storage container in a conveying direction transverse, preferably perpendicular, to their rotational axes. The invention further relates to a method in which interlocked bulk goods accommodated in such a storage container are withdrawn from the storage container by means of spiked shafts.

In accordance with the invention, the spiked shafts are arranged such that they engage with the bulk goods in order to withdraw them from above. On the free upper surface of the column of bulk goods formed in the storage container, the spiked shafts plunge into the bulk goods and in accordance with their plunging depth need therefore only wrench an uppermost layer of the particles of bulk goods out of the pile of bulk goods. Since the pile of bulk goods is carried off bit by bit from above by the action of the spiked shafts, the spiked shafts are always engaging with or plunging into a comparatively loose upper layer, to the depth of the plunging depth. By engaging with and withdrawing the particles of bulk goods in this way, the next layer beneath the current plunging depth is already loosened. If the column of bulk goods is continuously carried off, then it is even possible to withdraw the bulk goods in the lower region of the storage container where the pressure forces are at their greatest and the interlocking is therefore at its strongest, the forces acting between the particles of bulk goods when being withdrawn being smaller as compared to conventional methods. Using the invention, the withdrawal of the particles of bulk goods is configured to gently withdraw the particles of bulk goods and carry them off in portions.

The spiked shafts preferably convey the bulk goods into a fall-pipe arranged in the conveying direction of the spiked shafts. The fall-pipe comprises an upper opening through which a spiked shaft, expediently the last spiked shaft in the conveying direction of the spiked shafts, conveys the bulk goods into the fall-pipe. The fall-pipe is preferably open at the top, i.e. the upper opening is quire simply formed by inner cross-sectional area of an upper end of the fall-pipe. In principle, however, the upper opening could also be a lateral opening in the fall-pipe.

The fall-pipe preferably extends through the column of bulk goods. In this arrangement, it is formed such that it screens the bulk goods, preferably completely free-falling in the fall-pipe, from the surrounding column of bulk goods. It therefore preferably comprises a closed, i.e. uninterrupted, pipe casing along its length or height extending through the column of bulk goods, said pipe casing preferably being smooth on its outer side and preferably also on its inner side.

If the fall-pipe—or instead of this, another suitable withdrawing means which withdraws the bulk goods through the column of bulk goods—protrudes through the bulk goods as far as a central region of its free upper surface, preferably precisely as far as the centre of said surface, then a further advantage is achieved, namely a short transport path for the bulk goods transverse to the free upper surface.

In principle, this advantage also bears fruit in conjunction with conveyors other than spiked shafts, for example in conjunction with the rake type of conveyor which is in principle also suitable for carrying off the column of bulk goods. Such a rake conveyor comprises a plurality of rakes which are drawn along the free upper surface of the column of bulk goods by a traction means of the rake conveyor, in order to convey the bulk goods from a periphery of the surface towards the centre of the surface, i.e. to the withdrawing means. Since the rakes do not convey the bulk goods over the entire surface but only from the periphery to at most the centre of the surface, the load on the traction means is significantly reduced as compared to conveying over the entire surface. When one or more rake conveyors are arranged, a multiple-thread traction means is preferred over a merely single-thread traction means due to the force to be applied by the traction means, which despite the reduction in the length of the conveying path can still be considerable. A carrying-off means formed from spiked shafts does however have the great advantage over a rake conveyor that the bulk goods can be carried off in more precise portions. Although technically elaborate, the possibility should not however be excluded of carrying off the column of bulk goods using a combination of spiked shafts and a rake conveyor, as viewed in the conveying direction.

The spiked shafts are preferably jointly mounted in one frame such that they can rotate about their rotational axes. The frame is arranged in the storage container in such a way that it can be lowered, in order to carry off the column of bulk goods using the combination of conveying transverse to the rotational axes of the spiked shafts and lowering the spiked shafts. The frame can preferably be raised, for filling the storage container, wherein it can either be raised up to an upper end position before filling, or preferably gradually raised during filling and always above the increasing pile of bulk goods.

The frame is preferably mounted in the storage container such that it can be pivoted about a vertical pivoting axis. The pivoting mount preferably enables a circulatory pivoting movement of 360° about the pivoting axis. The pivoting movement for carrying off the pile of bulk goods can therefore advantageously be a rotational movement in a single rotational direction. If a fall-pipe extends through the column of bulk goods, the pivoting movement is performed about the fall-pipe, such that the pivoting axis is a longitudinal axis of the fall-pipe, preferably its central longitudinal axis. The spiked shaft frame can perform the pivoting movement relative to the fall-pipe or can be connected to an end of the fall-pipe in such a way that it cannot rotate about the pivoting axis.

The fall-pipe can preferably be changed in length and is shortened when the spiked shafts are lowered and lengthened before or during filling, preferably by a rising movement of the spiked shafts. To enable it to change in length, the fall-pipe is preferably formed as a telescopic pipe comprising at least two pipe segments which can be axially slid into each other, preferably axially guided on each other. In its simplest embodiment, the telescopic pipe can be formed by just two pipe segments, of which a lower one is fixed in the storage container and an upper one is axially movable relative to the lower one. More preferably, however, the telescopic pipe comprises a number of axially movable pipe segments which can be axially slid into each other and are respectively guided on each other in pairs. Expediently, each of the movable pipe segments is slide into the next lower pipe segment, respectively. If the pipe segments are formed as circular cylindrical pipe segments, an inner diameter of the thinnest pipe segment is preferably at least 500 mm, but more preferably at least 800 mm. The inner diameter increases successively from pipe segment to pipe segment by the wall thickness of the pipe segment to be inserted and the thickness of a circulatory gap between the pipe segments. The length of the pipe segments is preferably at least 1000 mm and at most 3000 mm. The pipe segments preferably overlap each other completely or at least over the majority of their lengths, when retracted.

In order to shorten the fall-pipe at a rate which corresponds to the lowering rate of the spiked shafts when the pile of bulk goods is carried off, an upper end of the fall-pipe, which forms the upper opening, can be mechanically connected to the frame which mounts the spiked shafts such that they can rotate, such that the frame slaves the upper end of the fall-pipe when the spiked shafts are lowered. It is sufficient for this purpose if the frame for example presses loosely onto the fall-pipe from above. Preferably, however, the frame is connected, such that it cannot move axially, to the end of the fall-pipe which forms the upper opening of the fall-pipe and is an upper pipe segment when the fall-pipe is formed as a telescopic pipe. In this way, the frame likewise slaves the fall-pipe during its rising movement, such that the lowering and rising movement of the spiked shafts is synchronised with the shortening and lengthening of the fall-pipe. When the fall-pipe is formed as a telescopic pipe, the pipe segments are connected to each other for this preferred way of extending the fall-pipe, such that each of the axially movable pipe segments slaves its next lower adjacent segment, if a number of axially movable pipe segments are provided.

In the preferred embodiment in which the spiked shafts can be pivoted about a pivoting axis in a frame, the frame comprises at least two frame parts or is formed by two frame parts, namely a lowering and rising frame and a pivoting frame. In the pivoting frame, the spiked shafts are mounted such that they can rotate about their rotational axes. The pivoting frame can be pivoted about the pivoting axis relative to the lowering and rising frame. The pivoting frame and the lowering and rising frame are preferably moved jointly along the pivoting axis, which is expediently achieved by a mechanical connection of the two frame parts which prevents the two frame parts from moving axially relative to each other. The lowering and rising frame and the pivoting frame can in particular be connected to each other by means of a purely rotary joint whose rotational axis is the pivoting axis of the pivoting frame.

In order to absorb a reaction moment resulting from the pivoting movement of the spiked shafts, the lowering and rising frame is supported on the storage container such that it cannot rotate about the pivoting axis. In the preferred embodiment in which the lowering and rising frame participate in the lowering and rising movement of the spiked shafts, the lowering and rising frame is of course supported on the storage container such that it can move in the direction of the lowering and rising movement. For this purpose, the storage container expediently forms at least one guiding cam which extends in the direction of the lowering and rising movement of the spiked shafts, i.e. preferably vertically. The lowering and rising frame forms at least one engaging member which is guided by the at least one guiding cam during the lowering and rising movement, wherein the guiding engagement simultaneously blocks a rotational movement of the lowering and rising frame relative to the storage container.

The engaging element is preferably a roller which is mounted on the lowering and rising frame such that it can rotate about a rotational axis transverse to the guiding cam. In order to prevent the lowering and rising frame from jamming, at least two engaging element are preferably arranged on the lowering and rising frame, along the guiding cam. The guiding cam is preferably a guiding rail, but can also in principle be a guiding groove.

A number of pivoting frames of the type described above can also be provided in the storage container, for example two pivoting frames arranged flush or three, four or even more pivoting frames which are preferably arranged in equal distribution about their common pivoting axis. The same applies to rake conveyers. If a number of pivoting frames are arranged, it is furthermore conceivable in principle for at least one of the pivoting frames to mount a rake conveyer and at least one other to mount spiked shafts.

A drive, which lowers the spiked shafts for carrying off the column of bulk goods and preferably also raises the spiked shafts for filling the storage container, is preferably regulated, but could in principle also be merely controlled. A motor of the drive is controlled or preferably regulated, such that the plunging depth of the spiked shafts into the pile of bulk goods remains constant while the spiked shafts are lowered. Preferably, the plunging depth is indirectly detected with the aid of a distance sensor, which can determine the vertical distance between the frame and the column of bulk goods situated beneath it. The sensor comprises a transmitter and a receiver, in order to scan the surface of the column of bulk goods and receive a reflected signal, from which a regulating variable for a motor regulator or a controlling variable for a motor controller of the drive is formed.

The spiked shafts are preferably held suspended in the storage container, i.e. a holding unit of the lowering and rising drive is a traction unit, for example a wire cable or a chain. Other lowering and rising mechanisms, for example a hydraulic drive, can in principle be used instead.

The above statements regarding preferably conveying by means of spiked shafts also apply in principle to a rake conveyor. Thus, the rake conveyor can in particular be arranged such that it can be pivoted and lowered and raised, using in principle the same manipulated mechanism.

The plunging depth of its rakes can likewise be controlled or preferably regulated, as described above for the preferred example of the spiked shafts.

Using overhead withdrawal in accordance with the invention, with the aid of spikes, in particular with the aid of an arrangement of spiked shafts, or with the aid of a rake conveyor—in this case, however, only in combination with a central withdrawing means—it is possible to store interlocking bulk goods in storage containers which are significantly larger than when using the withdrawing devices hitherto known for said bulk goods. The storage container of a storage device in accordance with the invention can have a storage volume of up to 80,000 m³ or an even larger storage volume. The storage container preferably forms a circular cylindrical storage space having a vertical longitudinal axis. The column of bulk goods can easily be 10 m or higher.

In order to make operation continuous, at least two storage devices in accordance with the invention are provided at the site of a storage facility and operated such that they are functionally adjusted to each other. In this way, one of the at least two storage devices can in particular be filled with the bulk goods, while the other storage device—already previously filled—is simultaneously emptied, in order to continuously fill and empty in alternating operation. A functional coupling can be formed by a common feeding device and/or a common withdrawing conveyor. A common withdrawing conveyor can in particular be provided beneath a fall-pipe of each of the storage devices.

An individual storage container is, however, also sufficient. In order to make the operation of an individual container continuous, feeding bulk goods into the storage container and withdrawing from the storage container can be adjusted to each other. The adjustment can in particular be such that the feeding rate corresponds to the withdrawing rate of the bulk goods. In principle, it is also conceivable for the carrying-off device to slowly travel upwards while carrying off the bulk goods, if for instance the feeding rate is at times greater than the carrying-off rate. However, when operating as an individual storage device, the storage container should also be completely emptied at reasonable time intervals.

While withdrawing the bulk goods through a fall-pipe which extends through the column of bulk goods in the storage container as far as a central region of the surface of the column is particularly advantageous in conjunction with the spiked shafts engaging from above in accordance with the invention, it can however in principle also be used with other carrying-off devices, in particular transverse conveyors which convey into the fall-pipe. The Applicant therefore reserves the right to direct a divisional application or also a subsequent priority application to the arrangement of a fall-pipe in conjunction with a carrying-off device in general, which carries off the bulk goods from the column of bulk goods and conveys them into the fall-pipe. However, the spiked shafts in accordance with the invention which engage with the bulk goods from above are a particularly preferred example embodiment of a carrying-off device which conveys transverse to the fall-pipe and into the fall-pipe.

An example embodiment of the invention is described below by way of figures. Features disclosed by the example embodiment, each individually and in any combination of features, advantageously develop the subjects of the claims. There is shown:

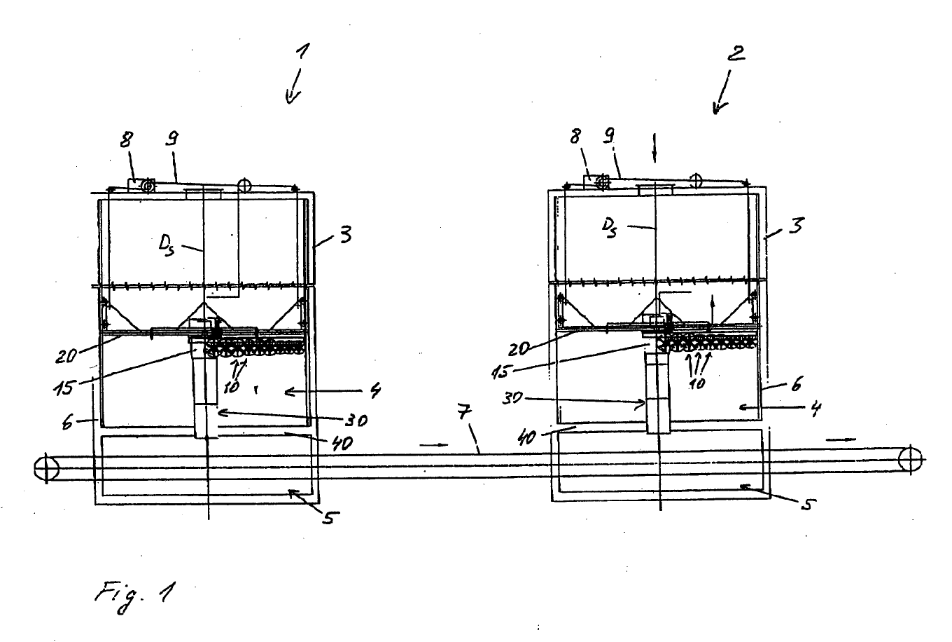

FIG. 1 a pair of storage devices comprising partially filled storage containers;

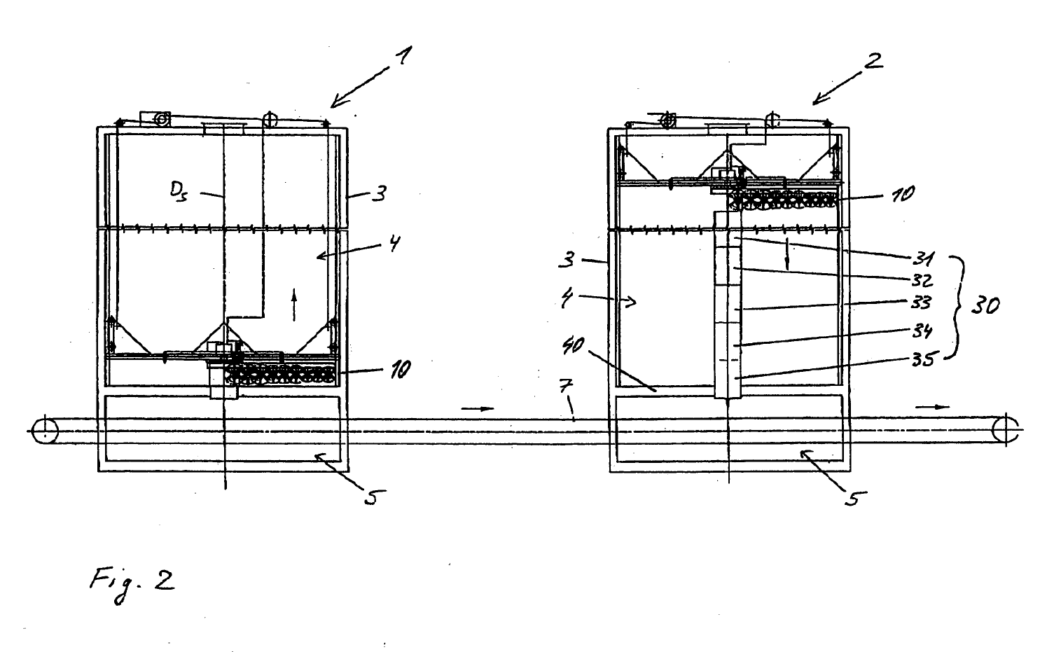

FIG. 2 the pair of storage devices of FIG. 1, after one storage container has been emptied and the other storage container has been filled;

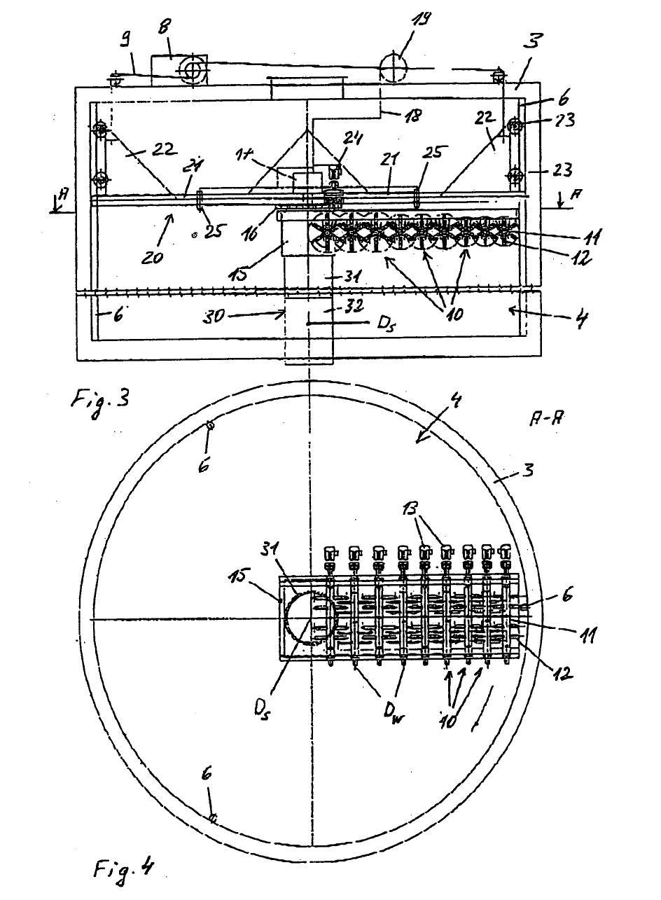

FIG. 3 an enlarged representation of a part of one of the storage devices of FIGS. 1 and 2;

FIG. 4 the storage device of FIG. 3, in a cross-section;

FIG. 5 the storage device of FIG. 3, in a view rotated by 90°;

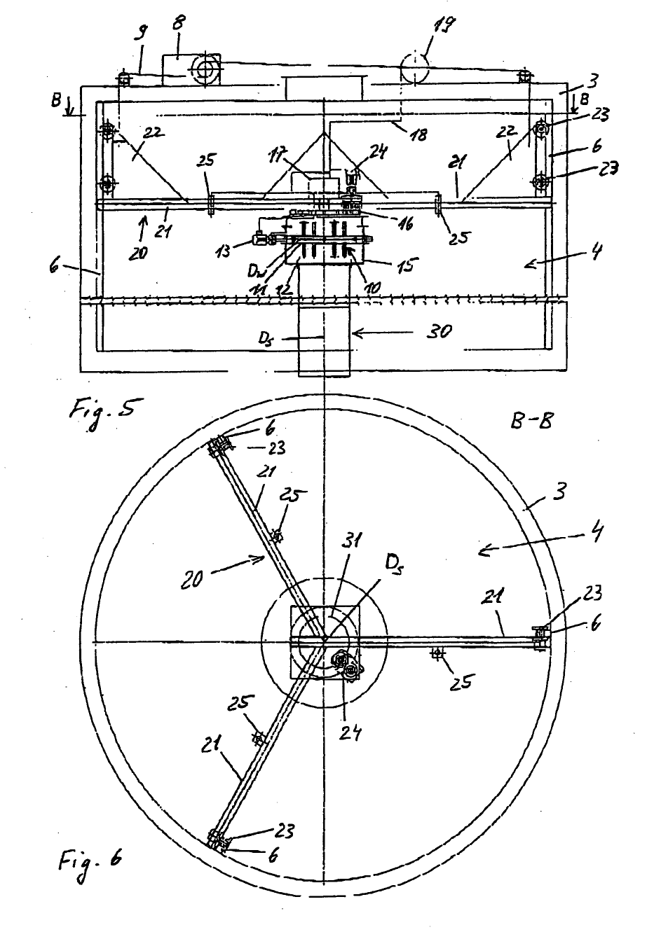

FIG. 6 the storage device in another cross-section;

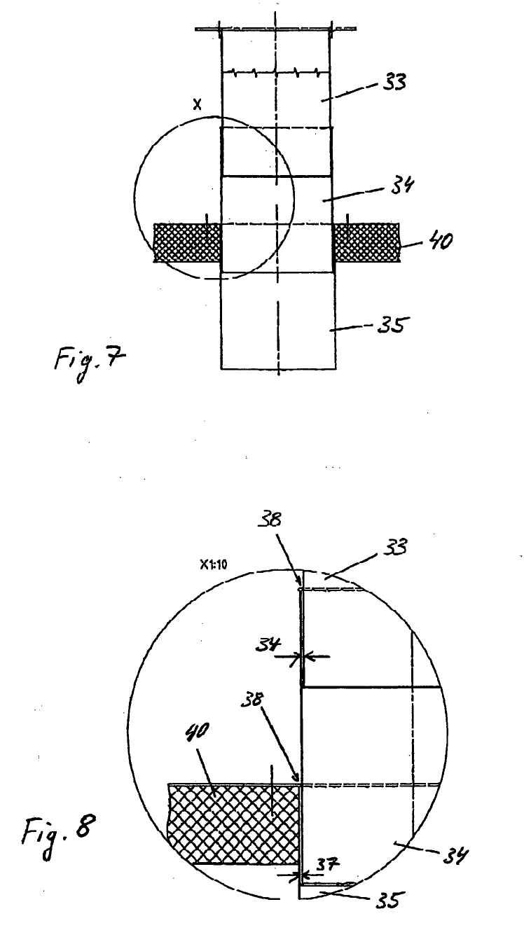

FIG. 7 a fall-pipe of the storage device, in a longitudinal section; and

FIG. 8 the detail “X” of FIG. 7.

FIG. 1 shows two storage devices 1 and 2 which—adjusted to each other—are alternately filled with bulk goods and emptied, in order to enable bulk goods to be continuously fed and withdrawn. Each of the two storage devices 1 and 2 is a silo comprising a vertically standing, circular annular cylindrical storage container 3. The storage devices 1 and 2 serve to store bulk goods consisting of or largely comprising interlocking particles of bulk goods, such as for example chips for OSB plates. The two storage devices 1 and 2 are formed identically, such that in the following, apart from the adjusted operation, only one of the storage devices 1 and 2 is ever described, representative for the other storage device as well.

The storage container 3 forms a sort of cellar 5 and, vertically above, a storage space 4 for the bulk goods. The storage space 4 and the cellar 5 are separated from each other by a floor 40. The bulk goods accommodated in the storage space 4 are piled up, from the floor 40, into a column of bulk goods. When the storage device 1 is emptied, the bulk goods are conveyed onto a withdrawing conveyor 7 and, lying on said withdrawing conveyor 7, withdrawn from the storage device. As in the example embodiment, the withdrawing conveyor 7 can in particular be a continuous conveyor, for example a belt conveyor. The withdrawing conveyor 7 extends through the cellar 5 of the storage container 3.

The withdrawing conveyor 7 likewise extends through the cellar 5 of the other storage device 2 and thus couples the two storage devices 1 and 2 to each other, in the sense that the same withdrawing conveyor 7 can be used to empty the storage device 1 when it conveys in the conveying direction indicated in FIG. 1 and, when the conveying direction is reversed, to empty the storage device 2.

In order to withdraw bulk goods from the storage space 4, a withdrawing device is provided, consisting of spiked shafts 10 and a fall-pipe 30. The spiked shafts 10 are rotary driven and plunge into the bulk goods via their spikes, to empty the storage container 3. They carry the bulk goods off on the free upper surface of the column of bulk goods and convey them into a fall-pipe 30. The bulk goods free-falls through the fall-pipe 30 and a lower outlet of the fall-pipe 30, onto the withdrawing conveyor 7. The fall-pipe 30 protrudes vertically up from the floor 40 and protrudes centrally through the column of bulk goods, i.e. it is co-axial with respect to the inner surface area of the side wall of the storage container 3. It forms a vertical conveying means based on gravity, in that the bulk goods conveyed into the fall-pipe 30 by the spiked shafts 10 free-fall downwards in the fall-pipe 30. The spiked shafts 10 together form a carrying-off device which carries off the bulk goods on the surface of the column of bulk goods bit by bit and conveys them perpendicular to the fall-pipe 30 through an upper inlet opening into the fall-pipe 30. The conveying direction of the spiked shafts 10 points perpendicular to the rotational axes of the spiked shafts 10 and also perpendicular to the longitudinal axis of the fall-pipe 30. The conveying direction of the spiked shafts 10 is furthermore—viewed as a whole—horizontal or at least substantially horizontal. During transverse conveying, the arrangement of spiked shafts 10 is rotary driven, i.e. pivoted, about a pivoting axis Dₛ which coincides with a central longitudinal axis of the fall-pipe 30 and the storage space 4.

FIGS. 1 and 2 illustrate the alternating operation of the two storage devices 1 and 2. FIG. 1 shows the two storage devices 1 and 2 in a state in which the storage device 1 is being emptied and the storage device 2 is being filled. The arrangement of the spiked shafts 10 of the storage device 1 is currently being moved downwards, i.e. lowered, in order to carry the pile of bulk goods off bit by bit. At the same time, the storage space 4 of the storage device 2 is filled with the aid of a feeding device (not shown). During filling, the arrangement of the spiked shafts 10 is constantly moved upwards above the growing column of bulk goods. The lowering and rising movements of the two arrangements of spiked shafts 10 are made clear in FIG. 1 by vertical directional arrows.

FIG. 2 shows the storage device 1 once it has been completely emptied and the storage device 2 once it has been completely filled and the lowering and rising drives have been switched. The reversal of the directional arrows for the vertical movement of the spiked shafts 10 is intended to indicate that the storage device 1 is now ready to be filled anew and the storage device 2 is now ready to be emptied.

Furthermore, it can also be seen from FIGS. 1 and 2 that the fall-pipe 30 can be changed in length. During the lowering movement of the spiked shafts 10, the fall-pipe 30 is shortened, and during the rising movement it is lengthened. In the example embodiment, the fall-pipe 30 is a telescopic pipe consisting of five pipe segments 31 to 35, as can best be seen in the storage device 2 in FIG. 2. The lowermost pipe segment 35 is fixedly connected to the floor 40, for example doweled to the floor 40. The withdrawing conveyor 7 runs vertically beneath the pipe segment 35. The pipe segment 35 forms an outage pipe on the lower facing side of which the free-falling bulk goods exit the fall-pipe 30 and fall onto the withdrawing conveyor 7. When shortening the fall-pipe 30, the upper pipe segment of each two consecutive extended pipe segments is slid into the next lower pipe segment, i.e. the uppermost pipe segment 31 is slid into the next pipe segment 32 in the downward direction, and together with said pipe segment slid into the then next pipe segment 33 and so on, until all the axially movable pipe segments 31 to 34 have been slid into the outage pipe 35 and the fall-pipe 30 is completely retracted. The completely retracted state is shown in FIG. 2 for the storage device 1. While carrying off the column of bulk goods, i.e. during the lowering movement of the spiked shafts 10, it must of course be ensured that the spiked shafts 10 are always conveying into the inlet opening of the fall-pipe 30. This means that the spiked shafts 10 are lowered and the fall-pipe 30 shortened—in the example embodiment, retracted—at the same rate. The arrangement of spiked shafts 10 is correspondingly connected to the uppermost pipe segment 31 such that it cannot be axially moved with respect to the longitudinal axis of the fall-pipe 30.

FIGS. 3 to 6 show the upper part of the storage device 2 in the state as in FIG. 2, i.e. after the storage container 3 has been completely filled and before beginning to carry the bulk goods off. FIG. 3 is an enlarged representation of the upper part of the storage device 2 in FIG. 2. FIG. 4 shows the cross-section A-A in FIG. 3. FIG. 5 shows the upper part of the storage device 2 in a view rotated by 90° as compared to FIG. 2 and FIG. 3, and FIG. 6 shows the cross-section B-B in FIG. 5. FIGS. 3 to 6 show in particular the spiked shafts 10 and their arrangement in the storage container 3, in greater detail than FIGS. 1 and 2. However, in the description below, reference should always also be made to FIGS. 1 and 2.

The spiked shafts 10 are each formed by a linear shaft 11 in the form of a pipe and radial spikes 12 projecting from the shaft. Six spikes 12 are arranged in equal distribution over the circumference of each of the shafts 11, as can be seen in FIG. 3. Four of these “spiked stars” are provided in the axial direction of each of the shafts 11, such that each of the spiked shafts 11 comprises twenty-four spikes 12. The spiked shafts 10 are arranged with their rotational axes D_{w} in parallel alongside each other in the horizontal plane and, arranged as a whole, pointing radially with respect to the pivoting axis Dₛ of the fall-pipe 30. In the direction of the rotational axes D_{w}, the spikes 12 of each two adjacent spiked shafts 10 are arranged offset with respect to each other such that the spikes 12 of each of the spiked shafts 10 overlap the spikes 12 of respectively adjacent spiked shaft 10, such that a mating engagement is achieved between all respectively adjacent spiked shafts 10, as can best be seen in FIG. 4.

Each of the spikes 12 is formed by a linear pipe section which is flattened at its peripheral free end, to form a tip. The diameter of the spiked shafts 10, measured as the diameter of an external cylinder which surrounds and contacts the tips of the spikes 12 of a spiked shaft 10, increases in the conveying direction of the spiked shafts 10. In the case of the spiked shafts 10 of the example embodiment, the spiked shafts 10 of an outer group exhibit a minimum equal diameter, the spiked shafts 10 of a middle group exhibit a medium equal diameter, and the spiked shafts 10 of an inner group exhibit a maximum equal diameter.

The spiked shafts 10 can be individually rotated about their rotational axes D_{w} in a frame, mounted such that they can be jointly pivoted about the pivoting axis Ds and jointly lowered and raised along the pivoting axis Dₛ. The frame is formed by a pivoting frame 15 and a lowering and rising frame 20. Each of the spiked shafts 10 is mounted in the pivoting frame 15 such that it can be rotated about its rotational axis D_{w}. The lowering and rising frame 20 is mounted in the storage container 3 such that it can be lowered and raised along the pivoting axis Dₛ and supported on the storage container 3 such that the lowering and rising frame 20 cannot rotate relative to the storage container 3. The pivoting frame 15 and the lowering and rising frame 20 together form a rotary joint whose rotational axis is the pivoting axis of the spiked shafts 10. Furthermore, the pivoting frame 15 and the lowering and rising frame 20 area connected to each other such that the pivoting frame 15 cannot move relative to the lowering and rising frame 20 along the pivoting axis Dₛ, i.e. the connection between the frames 15 and 20 is a purely rotary joint. One of the frames 15 and 20 forms a joint pin and the other forms a joint socket of the rotary joint. Two supports, spaced out from each other in parallel, project radially outwards from the part of the pivoting frame 15 forming the joint element. Said two supports form the left-side and right-side rotary bearing for the spiked shafts 10. Drive motors 13, preferably electric motors, for the spiked shafts 10 are respectively fastened alongside each other to one of the supports in an extension of the rotational axes D_{w}.

Each of the spiked shafts 10 is rotary driven by a motor 13 of its own. A joint drive, for example by means of a chain, would be conceivable as an alternative.

The rotational directions of the spiked shafts 10 are the same and are indicated in FIG. 3 using the example of the innermost spiked shaft 10. The rotational direction is such that the spikes 12 plunged into the bulk goods are moved with their tips in the conveying direction, i.e. towards the fall-pipe 30. During carrying off, the position of the spiked shafts 10 relative to the column of bulk goods situated beneath them is such that the shafts 11 are still situated above the bulk goods. In other words, the spikes 12 plunge into the bulk goods up to the shafts 11 at most, such that the length of the spikes 12—measured from the tips to the roots of the spikes 12 on the shafts 11—is equal to the maximum plunging depth.

The pivoting drive for the spiked shafts 10 is formed by an electric motor 24 and a gear transmission. The electric motor 24 is supported on the lowering and rising frame 20. The transmission comprises a drive gear which is rotary driven by the electric motor 24 and a driven gear 16 which meshes with the drive gear. The driven gear 16 is connected to the pivoting frame 15, secured against rotation. In the example embodiment, the outer toothing of a live ring forms the driven gear 16. The live ring simultaneously also forms the rotary joint between the pivoting frame 15 and the lowering and rising frame 20.

The lowering and rising frame 20 comprises three horizontal, linear support arms 21 which extend almost to the side wall of the storage container 3 and are offset by 120° about the pivoting axis Dₛ with respect to each other. A holding section 22 is fastened, completely rigidly, to the outer end of each of the support arms 21 and extends vertically from its support arm 21. A wire cable 9 of a winch motor 8 is fastened to the holding sections 22. The motor 8 is supported on a roof of the storage container 3. The cable winch comprising the motor 8 and the wire cable 9 forms a lowering and rising drive for the spiked shafts 10. The lowering and rising frame 20 and the pivoting frame 15 are suspended on the wire cable 9. Since the uppermost pipe segment 31 of the fall-pipe 30 is connected to the pivoting frame 15 such that it cannot move along the pivoting axis Dₛ, the cable winch 8, 9 simultaneously also forms a retracting and extending drive for the fall-pipe 30.

Furthermore, on each of the holding sections 22, two rollers 23—vertically spaced out from each other—are rotary mounted about rotational axes tangential to the side wall of the storage container 3. As can best be seen in FIG. 6, the rollers 23 engage with linear, vertical guiding rails 6 fastened to the inner surface area of the side wall of the storage container 3. In the example embodiment, the guiding rails 6 are square pipes. The engagement between the rollers 23 and the guiding rails 6 forms a rotational block for the lowering and rising frame 20, in order to support a reaction moment which acts on the lowering and rising frame 20 when the pivoting frame 15 pivots.

An ultrasound sensor 25 is fastened to each of the support arms 21 and is used as a distance sensor for a regulator for the motor 8. For when the spiked shafts 10 are lowered, the motor 8 is driven and regulated to maintain a predetermined plunge depth by the spikes 12 into the column of bulk goods. When filling the storage container 3, the motor 8 is driven and regulated to maintain a predetermined distance between the spikes 12 and the growing column of bulk goods. In both instances of driving, i.e. lowering and raising the spiked shafts 10, the surface of the column of bulk goods is scanned by means of the sensors 25 and from this the distance between the sensors 25 and the bulk goods is determined, in order to thence form the regulating variable for the regulator for the motor 8. This regulating variable, together with a predetermined guiding variable, is sent to the regulator for the motor 8. The regulator forms the manipulated variable for the motor 8 in accordance with the difference between the guiding variable and the regulating variable. The quantity of bulk goods which is conveyed into the fall-pipe 30 per unit of time results from the plunge depth of the spikes 12, the lowering rate, the rotational speed and the diameter of the spiked shafts 10 and the angular velocity of the pivoting frame 15. Correspondingly, the quantity of bulk goods conveyed per unit of time can be varied as desired by varying one or more of these parameters.

For the sake of completeness, reference should be made to the fact that the power supply for the motors 13, the pivoting motor 23 and the sensors 25 is indicated by dashed lines. Power is supplied via a cable 18 from which branches lead to the motor 23 and the sensors 25. The motors 13 are supplied via a sliding contact formed between the cable 18 and a sliding body 17. The sliding body 17 is fastened to the pivoting frame 15. A cable reel 19 is fastened to the roof of the storage container 3 and unwinds the cable 18, against a restoring spring force, when the spiked shafts 10 are lowered, and automatically winds the cable 18 back up, due to the spring force, when the spiked shafts 10 are raised.

FIG. 7 shows the outage pipe 35 and the two next pipes 34 and 33. FIG. 8 shows the detail “X” indicated in FIG. 7.

The outage pipe 35 extends through the floor 40 and is, as already mentioned, fixedly doweled to the floor 40. Its lower, open facing side forms the outage opening of the fall-pipe 30. The next pipe segment 34 can be axially retracted into the outage pipe 35. The two pipe segments 34 and 35 comprise a circulatory annular gap 37 of a particular width between them. The annular gap 37 is narrowed at the upper end of the outage pipe 35 and indicated there by 38. It exhibits a constant width over its entire remaining overlapping length of the two pipe segments 34 and 35, which is preferably at least 5 mm and at most 50 mm. The narrower gap 38, which exhibits a width of preferably at least 0.5 mm and at most 5 mm, causes the bulk goods forced through the upper narrow gap 38 when the spiked shafts 10 are lowered to be able to then fall downwards through the other gap 37. Furthermore, spacers project from the outer surface area of the inner pipe segment 34 which improve the axial linear guide of the pipe segments 34 and 35 on each other. The other pipe segments exhibit the same form of gaps 37 and 38 and spacer between them.

### REFERENCE NUMERALS

1 storage device
2 storage device
3 storage container
4 storage space
5 cellar
6 guiding cam, rail
7 withdrawing conveyor
8 motor
9 cable
10 spiked shaft
11 shaft
12 spike
13 motor
14 -
15 pivoting frame
16 gear
17 sliding body
18 power cable
19 cable reel
20 lowering and rising frame
21 support arm
22 holding section
23 engaging element, roller
24 motor
25 distance sensor
26 -
27 -
28 -
29 -
30 fall-pipe
31 pipe segment
32 pipe segment
33 pipe segment
34 pipe segment
35 pipe segment, outage pipe
36 -
37 gap
38 gap
39
40 floor
D_{w} rotational axis of the spiked shaft
Dₛ pivoting axis, longitudinal axis, vertical

1. A storage device for withdrawing interlocked bulk goods, comprising:
a) a storage container;
b) a feeding device for filling said storage container with said bulk goods;
c) and spiked shafts arranged in the storage container which are rotary driven about their rotational axes and mate with each other in order to convey the bulk goods to be withdrawn from the storage container in a conveying direction perpendicular to their rotational axes;
d) wherein said spiked shafts are arranged such that they engage with the bulk goods in order to withdraw them from above.

2. The storage device as set forth in claim 1, further comprising a withdrawing means protruding in terms of height through a column of bulk goods formed in the storage container as far as a central region of a free upper surface of said column of bulk goods, and wherein the conveying direction of the spiked shafts points from a periphery of the column of bulk goods, along a free upper surface, to said withdrawing means.

3. The storage device as set forth in claim 2, wherein the withdrawing means is arranged in the conveying direction of the spiked shafts and is a fall-pipe into which the spiked shafts convey the bulk goods.

4. The storage device as set forth in the preceding claim, wherein the fall-pipe can be changed in length, in order to adjust its height to a height of the column of bulk goods accommodated in the storage container.

5. The storage device as set forth in the preceding claim, wherein the fall-pipe comprises pipe segments which can be axially slid into each other and which slave each other when the fall-pipe is shortened, such that a telescopic pipe is formed.

6. The storage device as set forth claim 2, wherein the spiked shafts are arranged in the storage container such that they can be lowered and the withdrawing means can be changed in length, in order to shorten it when the spiked shafts are lowered.

7. The storage device as set forth in the preceding claim, wherein the spiked shafts are mounted in a frame which can be lowered, such that they can be rotated about their rotational axes, and wherein one end of the withdrawing means which forms an upper opening of the withdrawing means through which the spiked shafts convey the bulk goods into the withdrawing means is connected to said frame, such that when the frame is lowered, it slaves said end of the withdrawing means, in order to shorten the withdrawing means.

8. The storage device as set forth in claim 2, wherein a withdrawing conveyor is arranged beneath the withdrawing means, in order to withdraw the bulk goods.

9. The storage device as set forth claim 1, wherein the spiked shafts are mounted in a frame such that they can rotate about their rotational axes and said frame is arranged in the storage container such that it can be lowered and raised.

10. The storage device as set forth in the preceding claim, wherein the frame comprises a lowering and rising frame and a pivoting frame which can be jointly lowered and raised, and wherein said lowering and rising frame mounts said pivoting frame such that it can be pivoted about a pivoting axis and the pivoting frame mounts the spiked shafts such that they can be rotated about their rotational axes.

11. The storage device as set forth in the preceding claim, wherein a support for the lowering and rising frame is mounted to the storage containers such that it cannot rotate about the pivoting axis, in order to absorb a reaction moment necessary for the pivoting movement of the pivoting frame.

12. The storage device as set forth in the preceding claim, wherein the support, secured against rotation by the lowering and rising frame, is formed by at lest one guiding cam extending in the direction of the lowering and rising movement of the lowering and rising frame and at least one engaging element guided along said guiding cam.

13. The storage device as set forth in claim 9, further comprising a lowering and rising drive having at least one motor which is coupled to the frame, in order to lower the frame for withdrawing the bulk goods and to raise the frame for filling the storage container.

14. The storage device as set forth in the preceding claim, wherein said lowering and rising drive is a winch drive.

15. The storage device as set forth in claim 13, wherein the lowering and rising drive comprises a regulator or a controller for said at least one motor and at least one distance sensor which detects a vertical distance between a frame which mounts the spiked shafts and the bulk goods, and wherein said distance is fed to said regulator as a regulating variable or to said controller as a controlling variable, to form a manipulated variable for the at least one motor.

16. The storage device as set forth in claim 1, wherein a rate at which the spiked shafts are lowered for withdrawing the bulk goods is set in accordance with a plunging depth of the spiked shafts into the bulk goods, as determined by measurement.

17. A storage facility comprising
at least two storage devices, each storage device comprising:
a) a storage container,
b) a feeding device for filling said storage container with said bulk goods,
c) and spiked shafts arranged in the storage container which are rotary driven about their rotational axes and mate with each other in order to convey the bulk goods to be withdrawn from the storage container in a conveying direction perpendicular to their rotational axes, and
d) wherein said spiked shafts are arranged such that they engage with the bulk goods in order to withdraw them from above;
wherein the at least two storage devices are connected to each other by a common feeding device and/or a common withdrawing conveyor, in order to be able to alternately fill and empty the storage container of one storage device and the container of the at least one other storage device.

18. A storage device for interlocking bulk goods, comprising:
a) a storage container;
b) a feeding device for filling said storage container with said bulk goods;
c) a withdrawing means which protrudes in terms of height through a column of bulk goods formed in the storage container as far as a central region of a free upper surface of said column of bulk goods;
d) and a rake conveyor arranged in the storage container, comprising a traction means and rakes drawn by said traction means which engage with the bulk goods on said free upper surface of the column of bulk goods, in order to convey the bulk goods, on its own or together with a conveyor of a different design, in a conveying direction from the periphery of the surface of the column of bulk goods to said withdrawing means.

19. A method for withdraw interlocked bulk goods from a storage container, wherein a carrying-off means arranged in said storage container and formed by spiked shafts or/and at least one rake conveyor engages with the column of bulk goods on a free upper surface of a column of bulk goods formed in the storage container from the bulk goods and conveys said bulk goods along said surface to a withdrawing means which transfers the bulk goods downwards onto a withdrawing conveyor.

20. The method as set forth in the preceding claim, wherein the bulk goods fall through the withdrawing means.

21. The method as set forth in claim 19, wherein the withdrawing means protrudes in terms of height through the column of bulk goods as far as a central region of its free upper surface, such that the bulk goods on the surface of the column of bulk goods are only conveyed into the central region from a periphery of the surface.

22. The storage device as set forth in claim 2, wherein the withdrawing means is formed by a fall-pipe.

23. The storage device as set forth in claim 5, wherein said axially movable pipe segments also slave each other when the fall-pipe is extended.

24. The storage device as set forth in claim 12, wherein the guiding cam is connected to a side wall of the storage container such that it cannot rotate about the pivoting axis.

25. The storage device as set forth in claim 12, wherein said engaging element is connected to the lowering and rising frame such that it cannot rotate about the pivoting axis.

26. The method as set forth in claim 19, wherein said withdrawing means is a vertical conveying means.
